(19) United States
(12) Patent Application Publication
(10) Pub. No.: US 2011/0067545 A1
(43) Pub. Date: Mar. 24, 2011

(54) MANDOLIN

(76) Inventor: Rodney Wilson Robbins, Florence, AL (US)

(21) Appl. No.: 12/562,333

(22) Filed: Sep. 18, 2009

(51) Int. Cl. B26D 3/00

(52) U.S. Cl. 83/698.71

(57) ABSTRACT

A mandolin includes a food deck having an adjustable first food deck and a fixed second food deck. A slide selectively engages food products as they are moved along the food deck. A parallel cutting blade is positioned between the first food deck and the second food deck, wherein the parallel cutting blade cuts food product along a plane which is substantially parallel to a plane in which an upper surface of the second food deck lies. A plurality of elongated perpendicular cutting blades mounted along the first food deck for engagement with food product prior to engagement of the food product with the parallel cutting blade, the elongated cutting blades being oriented to longitudinally extend along an axis substantially parallel to the longitudinal axis of the food deck and to cut the food product in a plane which is substantially perpendicular to the plane in which the upper surface of the first food deck lies and which extends substantially parallel to the longitudinal axis of the food deck. The slide includes a series of transverse slide cutting blades. The slide cutting blades are oriented to cut food products along a plane which is substantially perpendicular to the upper surface of the food deck when the slide is positioned for operation adjacent the food deck and perpendicular to the longitudinal axis of the food deck,

### BACKGROUND OF THE INVENTION

1. Field of the Invention

The present invention relates to food preparation instruments. More particular, the invention relates to a mandolin constructed to provide for dicing of food products in a controlled, convenient and safe manner.

2. Description of the Related Art

As those skilled in the art will certainly appreciate, a mandolin is a food preparation instrument used for slicing and cutting food products. Various cuts can be achieved using a mandolin by adjusting the blades of the mandolin and the orientation of the food product as it passes across the cutting blades of the mandolin.

In its most basic configuration, a mandolin includes first and second food decks, or working surfaces, one of which can be adjusted in height. A cutting blade is positioned between the first and second food decks, such that a food item is slid along the adjustable first food deck until it reaches a cutting blade mounted on, or adjacent to, the fixed second food deck, slicing it and letting it fall into a collection located beneath the first and second food decks. A variety of blade configurations are known for use in conjunction with mandolins, including the use of perpendicular blades that slice the food product into strips. As a result, mandolins are capable of cutting food products in several widths and thicknesses. Mandolins also are known which allow one to makes slices, waffle cuts and crinkle cuts with firm vegetables, fruits and/or other food products.

A mandolin offers the advantage of making cuts that are uniform in thickness. In addition, mandolins allow for cooks to make slices that can be very thin, with much less effort than would be required cutting the product with a knife or other blade, or even a food processor.

Those skilled in the art appreciate the versatility offered by a mandolin. As such, the present invention extends the functionality of traditional mandolins by providing a structure which allows for improved cutting variety in conjunction with enhanced convenience and user ergonomics.

### SUMMARY OF THE INVENTION

It is, therefore, an object of the present invention to provide a mandolin including a food deck having an adjustable first food deck and a fixed second food deck. A slide selectively engages food products as they are moved along the food deck. A parallel cutting blade is positioned between the first food deck and the second food deck, wherein the parallel cutting blade cuts food product along a plane which is substantially parallel to a plane in which an upper surface of the second food deck lies. A plurality of elongated perpendicular cutting blades mounted along the first food deck for engagement with food product prior to engagement of the food product with the parallel cutting blade, the elongated cutting blades being oriented to longitudinally extend along an axis substantially parallel to the longitudinal axis of the food deck and to cut the food product in a plane which is substantially perpendicular to the plane in which the upper surface of the first food deck lies and which extends substantially parallel to the longitudinal axis of the food deck. The slide includes a series of transverse slide cutting blades. The slide cutting blades are oriented to cut food products along a plane which is substantially perpendicular to the upper surface of the food deck when the slide is positioned for operation adjacent the food deck and perpendicular to the longitudinal axis of the food deck.

It is also an object of the present invention to provide a mandolin wherein the mandolin includes a first rail and a second rail supporting the food deck.

It is also an object of the present invention to provide a mandolin further including a first leg and a second leg respectively depending from the first rail and the second rail for supporting the food deck at a desired angular orientation.

It is a further object of the present invention to provide a mandolin wherein the food deck includes a first end and a second end, and the first food deck constitutes the first end of the food deck while the second food deck constitutes the second end of the food deck, such that a user may move food product between the first end and the second end of the food deck in a manner causing the slicing of the food product.

It is also an object of the present invention to provide a mandolin wherein the first food deck includes a first end and a second end, and the second end of the first food deck is adjustable relative to the parallel cutting blade and the second food deck.

It is another object of the present invention to provide a mandolin including a rotatable camming surface acting upon the second end of the first food deck in a manner allowing for raising and lowering of the second end of the first food deck.

It is a further object of the present invention to provide a mandolin wherein the second end of the first food deck includes a plurality of longitudinally extending slots oriented substantially parallel to the longitudinal axis of the food deck and a plurality of elongated perpendicular cutting blades mounted beneath the first food deck for selective extension through the longitudinally extending slots.

It is also an object of the present invention to provide a mandolin wherein elongated cutting blades are oriented to longitudinally extend along an axis substantially parallel to the longitudinal axis of the food deck and to cut the food product in a plane which is substantially perpendicular to the plane in which the upper surface of the first food deck lies and which extends substantially parallel to the longitudinal axis of the food deck.

It is another object of the present invention to provide a mandolin wherein the elongated perpendicular cutting blades are aligned with the slots formed in the second end of the first food deck for movement between a first storage position where the elongated perpendicular cutting blades are stored beneath the first food deck and a second use position where the elongated perpendicular cutting blades extend through the slots formed in the second end of the first food deck.

It is a further object of the present invention to provide a mandolin wherein the elongated perpendicular cutting blades are supported by a blade support assembly rotationally supporting the elongated perpendicular cutting blades for movement between the storage position and the use position.

It is also an object of the present invention to provide a mandolin wherein the slide includes a food support capsule mounted between a first end and the second end of the slide. The capsule is shaped and dimensioned for receiving food product and supporting the food product along a position such that the food product may be brought into engagement with the elongated perpendicular cutting blades and the parallel blade.

It is a further object of the present invention to provide a mandolin wherein the capsule includes an outer housing that is substantially cylindrical in shape and includes a first open end and a second open end.

It is also an object of the present invention to provide a mandolin wherein transverse slide cutting blades are mounted within the outer housing at a position adjacent the second open end of the outer housing.

It is another object of the present invention to provide a mandolin including a compression member that holds the food product as it is positioned within the outer housing and forces the food from the first open end of the outer housing, toward the second open end of the outer housing and through the slide cutting blades at the first open end of the outer housing.

It is a further object of the present invention to provide a mandolin including wherein the slide cutting blades are obliquely oriented.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top perspective view of the mandolin in accordance with the present invention.

FIG. 2 is a side plan view of the mandolin shown with reference to FIG. 1.

FIG. 3 is an exploded bottom perspective view of the mandolin shown with reference to FIG. 2.

FIGS. 4, 5, 6 and 7 are respectively a top perspective view, a bottom perspective view, a cross sectional view along the line 6-6 in FIG. 4 and an exploded view of the slide of the mandolin shown with reference to FIG. 1.

FIGS. 8, 8A, 9, 9A, 10, 11, 11A, 12, 13, and 13A are various views showing operation of the present mandolin.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

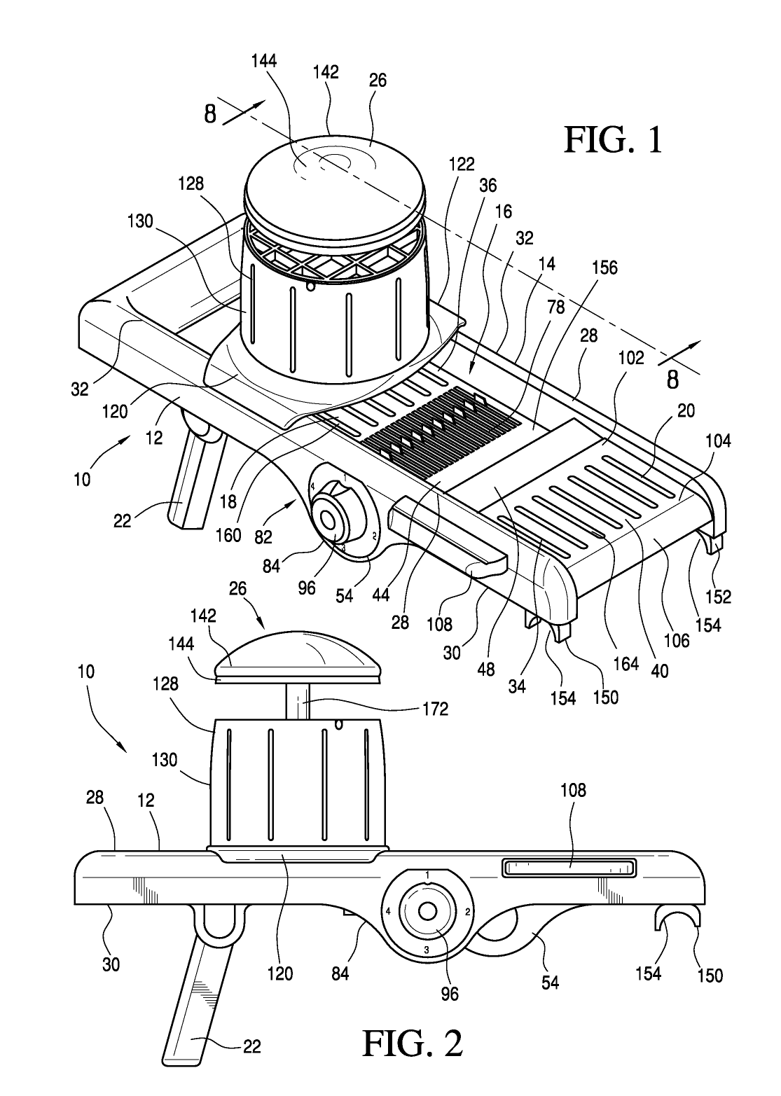

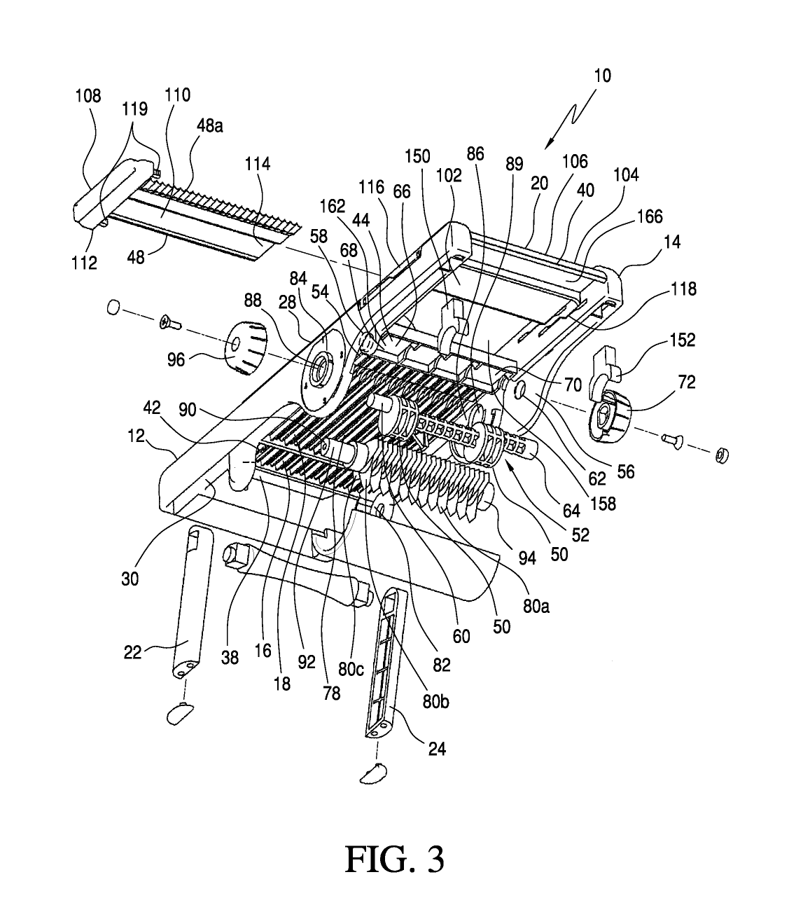

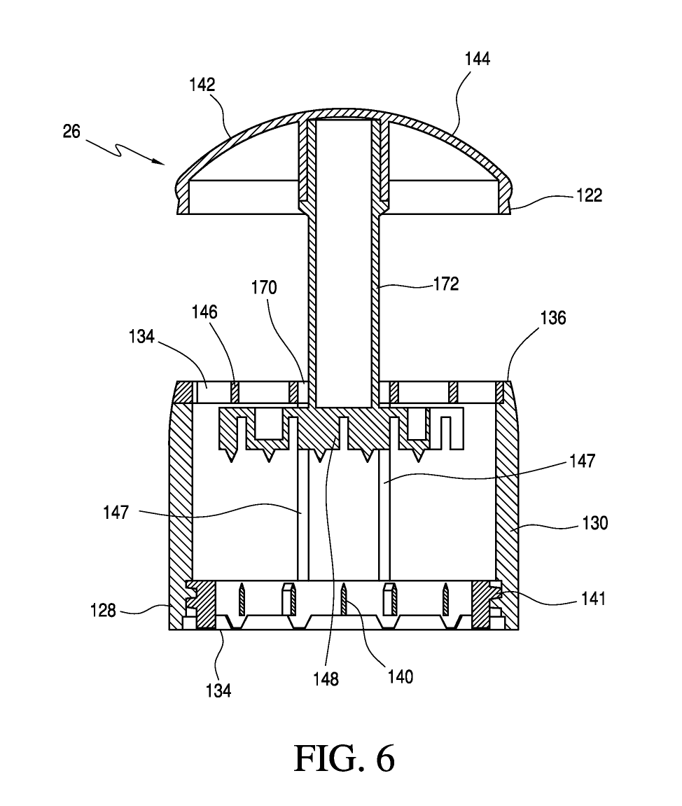

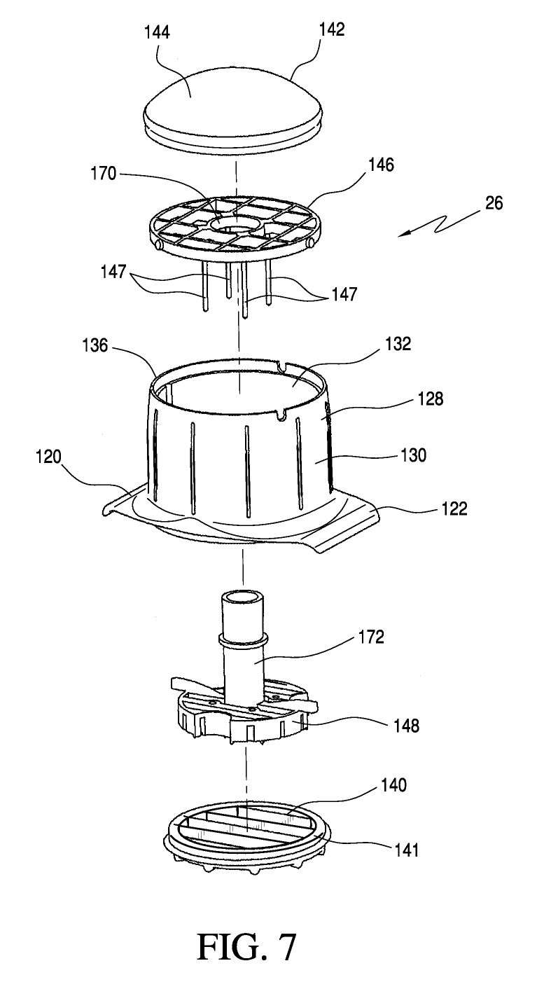

In accordance with the present invention, and with reference to FIGS. 1 to 13A, a mandolin 10 is disclosed. The mandolin 10 includes a first rail 12 and a second rail 14 supporting a food deck 16 having an upper surface 156 and a lower surface 158. The food deck 16 is composed of a first food deck 18 (having an upper surface 160 and a lower surface 162) and a second food deck 20 (having an upper surface 164 and a lower surface 166). The first food deck 18 is adjustably supported between the first and second rails 12, 14, while the second food deck 20 is fixedly mounted between the first and second rails 12, 14. As will be discussed below in greater detail, a first leg 22 and a second leg 24 respectively depend from one end of the first rail 12 and the second rail 14 for supporting the food deck 16 at a desired angular orientation. The mandolin 10 is further provided with a slide 26 which is used to engage food products as they are moved along the food deck 16 in a manner described below in greater detail.

The first rail 12 and the second rail 14 are elongated members. Each of the first rail 12 and the second rail 14 includes a generally rectangular cross section when viewed along a plane extending transverse to the longitudinal axis of the first rail 12 or the second rail 14. Looking to the cross sectional view of the first and second rails 12, 14, they include a top end 28 upon which the slide 26 rides and a bottom end 30. The top end 28 is provided with a substantially convex upper surface 32 shaped and dimensioned to enhance the ability of the slide 26 to move along the first and second rails 12, 14 as it is drawn up and down the upper surface 156 of the food deck 16.

As mentioned above, the food deck 16 is supported between the first rail 12 and second rail 14, and the first lateral side 34 and second lateral side 36 of the food deck 16 are therefore secured to the respective first rail 12 and second rail 14. The food deck 16 is provided with a first end 38 and a second end 40. The adjustable first food deck 18 may be thought of as constituting the first end 38 of the food deck 16 while the fixed second food deck 20 may be thought of as constituting the second end 40 of the food deck 16. As such, a user may move a food product between the first end 38 and the second end 40 of the food deck 16 in a manner causing the slicing of the food in a desired configuration.

The adjustable first food deck 18 is provided with a first end 42 and a second end 44. The first end 42 forms the distal end 46 of the food deck 16 and is secured between the first rail 12 and the second 14 in a manner allowing pivoting of the first end 42 while the second end 44 of the first food deck 18 is adjusted in the manner discussed below in greater detail. The second end 44 is positioned adjacent the fixed second food deck 20 and the parallel cutting (or slicing) blade 48; that is, the cutting blade which cuts food product along a plane which is substantially parallel to the plane in which the upper surface 164 of the second food deck 20 lies. The second end 44 is adjustable relative to the parallel cutting blade 48 and the second food deck 20. Adjustment of the second end 44 of the first food deck 18 is achieved by the provision of a camming member 52 including rotatable camming surfaces 50 which act upon the second end 44 of the first food deck 18 in a manner allowing for raising and lowering of the second end 44 of the first food deck 18 relative to the second food deck 20 and the parallel cutting blade 48.

The adjustment mechanism of the first food deck 18 includes a camming member 52 rotatably secured at a position beneath the second end 44 of the first food deck 18. By adjusting the position of the second end 44 of the first food deck 18 relative to the parallel cutting blade 48 and the second food deck 20, one is able to adjust the thickness of the cuts made in accordance with the present invention. Preferably, and as will be appreciated based upon the following disclosure, the second end 44 of the first food deck may be adjusted to provide for ⅛″, ¼″ and ½″ cuts depending upon the orientation of the camming member 52. The adjustment mechanism includes a first adjustment support bracket 54 extending downwardly from the bottom end 30 the first rail 12 and a second adjustment support bracket 56 extending downwardly from the bottom end 30 of the second rail 14. The first adjustment support bracket 54 includes a support aperture 58 shaped and dimensioned for rotationally supporting a first end 60 of the camming member 52. The second adjustment support bracket 56 includes a support aperture 62 shaped and dimensioned for rotationally supporting a second end 64 of the camming member 52.

The underside 66 of the second end 44 of the first food deck 18 is provided with a first recess 68 and a second recess 70 along opposite sides of the food deck 16, in particular, the first end 42 of the first food deck 18. The first circular recess 68 and the second circular recess 70 are shaped and dimensioned for engagement with the camming surfaces 50 of the camming member 52. Since the camming member 52 is provided with eccentric outer camming surfaces 50, rotation of the camming member 52 adjusts the relative position of the second end 44 of the first food deck 18. Controlled movement of the camming member 52, and accordingly the position of the second end 44 of the first food deck 18, is achieved by the provision of a handle 72 at the second end 64 of the camming member 52. The handle 72 includes stop members (not shown) that interact with stop members (not shown) formed along the outer surface of the first adjustment support bracket 54 to control the rotational movement of the camming member 52 for adjusting which portion of the camming surface 50 engages the recesses 68, 70 along the underside 66 of the second end 44 of the first food deck 18 to ultimately control the relative position of the second end 44 of the first food deck 18. Stop members such as those employed in accordance with the present invention are commonly employed in rotating structures and may be implemented in a variety of manners known to those skilled in the art.

The second end 44 of the first food deck 18 is also provided with a plurality of longitudinally extending slots 78. In particular, each of the slots 78 includes a longitudinal axis which is oriented substantially parallel to the longitudinal axis of the food deck 16. The slots 78 provide access for elongated perpendicular cutting blades (or julienne blades) 80a, 80b, 80c which are mounted beneath the first food deck 18. The elongated perpendicular cutting blades 80a, 80b, 80c are oriented to longitudinally extend along an axis substantially parallel to the longitudinal axis of the food deck 16 and to cut the food product in a plane which is substantially perpendicular to the plane in which the upper surface 160 of the first food deck 18 lies and which extends substantially parallel to the longitudinal axis of the food deck 16.

More particularly, the plurality of elongated perpendicular cutting blades 80a, 80b, 80c are mounted beneath the first food deck 18. The elongated perpendicular cutting blades 80a, 80b, 80c are aligned with the slots 78 formed in the second end 44 of the first food deck 18 for movement between a first storage position where the elongated perpendicular cutting blades 80 are stored beneath the first food deck 18 and a second use position where one set of the elongated perpendicular cutting blades 80a, 80b, 80c extend through the slots 78 formed in the second end 44 of the first food deck 18,

The elongated perpendicular cutting blades 80a, 80b, 80c are supported by a blade support assembly 82. The blade support assembly 82 includes a first support bracket 84 extending downwardly from the bottom end 30 of the first rail 12 and a second support bracket 86 extending downwardly from the bottom end 30 of the second rail 14. The first support bracket 84 includes a support aperture 88 shaped and dimensioned for rotationally supporting a first end 90 of a support rod 92 to which the various elongated perpendicular cutting blades 80a, 80b, 80c are secured. The second support bracket 86 includes a support aperture 89 shaped and dimensioned for rotationally supporting a second end 94 of the support rod 92 to which the various elongated perpendicular cutting blades 80 are secured.

Controlled movement of the blade support assembly 82, in particular, the support rod 92 upon which the elongated perpendicular cutting blades 80a, 80b, 80c are mounted, is achieved by the provision of a handle 96 at the first end 90 of the support rod 92. The handle 96 includes stop members (not shown) that interact with stop members (not shown) formed along the outer surface of the first support bracket 84 to control the rotational movement of the blade support assembly 82 for moving the elongated perpendicular cutting blades 80 between their storage position and their use position. The stop members further allow for various blade positions when the blade support assembly 82 is in its use position.

In accordance with a preferred embodiment of the present invention, the blade support assembly 82 is provided with 3 sets of blades 80a, 80b, 80c oriented for selective exposure as the blade support assembly 82 is rotated through 90° turns. As such, the blade support assembly 82 may be rotated through a storage position with no blades 80a, 80b, 80c exposed through the slots 78, a first use position with the first set of blades 80a exposed through the slots 78, a second use position with the second set of blades 80b exposed through the slots 78 and a third use position with a third set of blades 80c exposed through the slots 78.

As mentioned above, the food deck 16 includes a first food deck 18 and a second food deck 20. The second food deck 20 may be thought of as constituting the second end 40 of the food deck 16 and the user may move food product between the first end 38 and the second end 40 of the food deck 16 in a manner causing the slicing of the food in a desired configuration. With this in mind, the second food deck 20 is provided with a first end 102 and a second end 104. The first end 102 is positioned adjacent the fixed first food deck 18 and the second end 104 forms the proximal end 106 of the food deck 16.

Referring in particular to FIGS. 1, 2 and 3, the parallel cutting blade 48 is mounted between the first rail 12 and the second rail 14 at a position such that the cutting portion of the parallel cutting blade 48 is located between the first food deck 18 and the second food deck 20. The parallel cutting blade 48 is mounted upon a blade assembly 108. The blade assembly 108, of which the parallel cutting blade 48 forms a portion, is shaped and dimensioned for selective mounting between the first and second rails 12, 14 at a position as described above. As such, the blade assembly 108 includes a blade housing 110 having a first end 112 and second end 114. The first end 112 of the blade housing 110 is shaped and dimensioned for placement within and selective engagement with, a recess, or aperture, 116 formed in the first rail 12 and the second end 114 of the blade housing 110 is shaped and dimensioned for passing fully through the recess 116 of the first rail 12 and for selective engagement within a recess 118 formed in the second rail 14. In practice, the blade assembly 108 is selectively mounted between the first rail 12 and the second rail 14 by passing the second end 114 of the blade housing 110 through the recess, or aperture, 116, formed along the sidewall of the first rail 12. The blade assembly 108 is further moved across the food deck 16 until the second end 114 of the blade assembly 108 seats within the recess 118 formed in the sidewall of the second rail 14 and the first end 112 of the blade housing 110 seats within the recess 116 formed in the sidewall of the first rail 12. The first end 112 of the blade housing 110 and the second end 114 of the blade housing 110 are frictionally engaged within the recesses 116, 118 of the first and second rails 12, 14. In accordance with a preferred embodiment, clips 119 on the first end 112 engage the recess 118 for selective attachment.

In accordance with a preferred embodiment of the present invention, the blade assembly 108 is provided with first and second parallel cutting blades 48, 48a along the forward edge and the rearward edge of the blade assembly 108. In accordance with a preferred embodiment, the first parallel cutting blade 48 provides for a crinkle cut and the second parallel cutting blade 48a provides for a straight cut. As such, different cuts may be achieved by simply flipping the blade assembly 108 over. With this in mind, the first end 112 and the second end 114 of the blade assembly 108 must be symmetrically constructed to allow for switching between the parallel cutting blade 48 along the forward edge of the blade assembly 108 and the parallel cutting blade 48a along the rearward edge of the blade assembly 108. As those skilled in the art will appreciate, the terms forward edge and rearward edge are relative terms given the fact the blade assembly may be flipped over altering which blade is actually functioning in cutting the food product passing there across.

Referring to FIGS. 1, 2 and 3, an angled orientation comfortable for the user of the present mandolin 10 is achieved by the provision of a first leg 22 and a second leg 24 depending from the first rail 12 and the second rail 14 adjacent the distal end 46 of the food deck 16 for supporting the food deck 16 at a desired angular orientation. The first leg 22 and the second leg 24 are pivotally supported by the first rail 12 and the second rail 14 for movement between an extended use orientation and an aligned storage orientation. First and second forward legs 150, 152 are also provided at the proximal end 106 of the food deck 16. Each of these legs 150, 152 include a concave recess 154 for gripping a support member (not shown) and stabilizing the mandolin 10 during use.

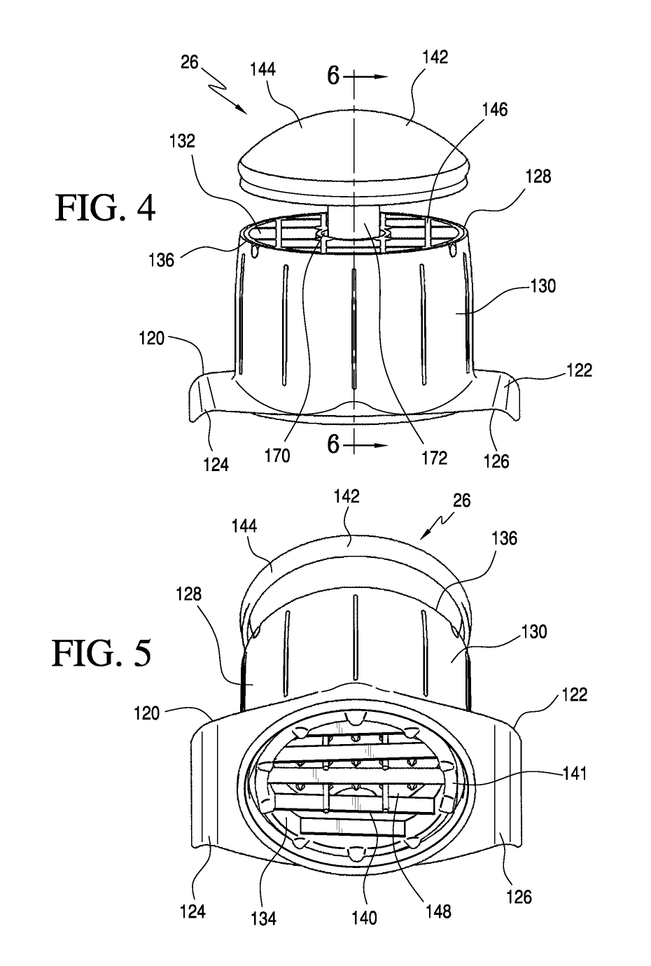

Referring now in particular to FIGS. 4, 5, 6, and 7, the mandolin 10 is further provided with a slide 26 which is used to engage food products as they are moved along the food deck 16 in a manner described below in greater detail. As briefly mentioned above, the slide 26 includes a first end 120 shaped and dimensioned for riding upon the top end 32 of the first rail 12 and a second end 122 shaped and dimensioned for riding upon the top end 28 of the second rail 14. As such, the first end 120 of the slide 26 includes a concave recess 124 shaped and dimensioned to conform with the convex surface 32 defined at the top end 28 of the first rail 12 and the second end 122 of the slide 26 includes a concave recess 126 shaped and dimensioned to conform with the convex surface 32 defined at the top end 28 of the second rail 14.

A food support capsule 128 is mounted between the first end 120 and the second end 122 of the slide 26. As will be discussed below, the capsule 128 is shaped and dimensioned for receiving food product and supporting the food product along a position such that the food product may be brought into engagement with the elongated parallel cutting blades 80 and the parallel cutting blade 48.

The capsule 128 includes an outer housing 130. The outer housing 130 of the capsule 128 is substantially cylindrical in shape and includes a first open end 132 and a second open end 134. The first open end 132 is along the upper side 136 of the slide 26, that is, the portion of the slide 26 which faces away from the food deck 16 during operation. A prong assembly 146 is secured at the first open end 132 for engagement with food products via downwardly extending prongs 147 and guidance of the compression member 142 via a central aperture 170 formed therein. The second open end 134 is positioned along the bottom surface 138 of the slide 26 and faces the food deck 16 during operation.

A series of the transverse slide cutting blades 140 are mounted within the outer housing 130 at a position adjacent the second open end 134 of the outer housing 130. The transverse slide cutting blades 140 are mounted upon a support housing 141 which is selectively attached to the outer housing 130 at a portion adjacent the open second end 134. For example, the support housing 141 is selectively screwed into position along the open second end 134 of the outer housing 130. As a result, it is contemplated a plurality of interchangeable cutting blades may be provided, allowing one to selectively change blades depending upon a desired cut. The slide cutting blades 140 are oriented to extend from the first end 120 to the second end 122 of the slide 26 so as to cut food products along a plane which is substantially perpendicular to the upper surface 156 of the food deck 16 (when the slide 26 is positioned for operation adjacent the food deck 16) and perpendicular to the longitudinal axis of the food deck 16. As such, the slide cutting blades 140 are oriented to cut food product as it is forced from the first open end 132 of the outer housing 130 to the second open end 134 of the outer housing 130. After being cut by the slide cutting blades 140, the food product is forced out of the second open end 134 of the outer housing 130 where it is cut by the transverse slide cutting blades 140 in a manner discussed below in greater detail.

The slide 26 is further provided with a compression member 142 that holds the food as it is positioned within the outer housing 130 and forces the food from the first open end 132 of the outer housing 130, toward the second open end 134 of the outer housing 130 and through the slide cutting blades 140 at the first open end 132 of the outer housing 130, causing cutting of the food product along the cutting edges defined by the slide cutting blades. In accordance with a preferred embodiment, the blades 140 are mounted at an oblique angle relative to each other (see FIGS. 5, 9A, 11A, 12A, and 13A). The obliquely oriented blades 140 allow for easier passage of the food therethrough. The compression member 142 is composed of a grip 144 and a plunger 148 directly engaging the food product and connected to the grip 144 via a central shaft 172.

In practice, the food deck 16 is oriented with the elongated perpendicular cutting blades 80 in their use position extending upwardly through the slots 78 and the parallel blade 48 positioned to extend between the first rail 12 and the second rail 14. Food product is then placed within the open second end 134 of the outer housing 130 with the compression member 142 in place and the slide cutting blades 140 removed to allow for placement of the food product within the outer housing 130. With the food product within the outer housing 130, the slide cutting blades 140 are positioned at the open second end 134 with the food product between the slide cutting blades 140 and the compression member 142. The mandolin 10 is then set for the desired julienne, that is, the desired set of elongated perpendicular cutting blades 80a, 80b, 80c are selected by adjusting the handle 96 of the blade support assembly 82, and the position of the second end 40 of the first food deck 18 is set by adjusting the handle 72 of the camming member 52 so the thickness of the cut made by the parallel cutting blade 48, 48a is properly set.

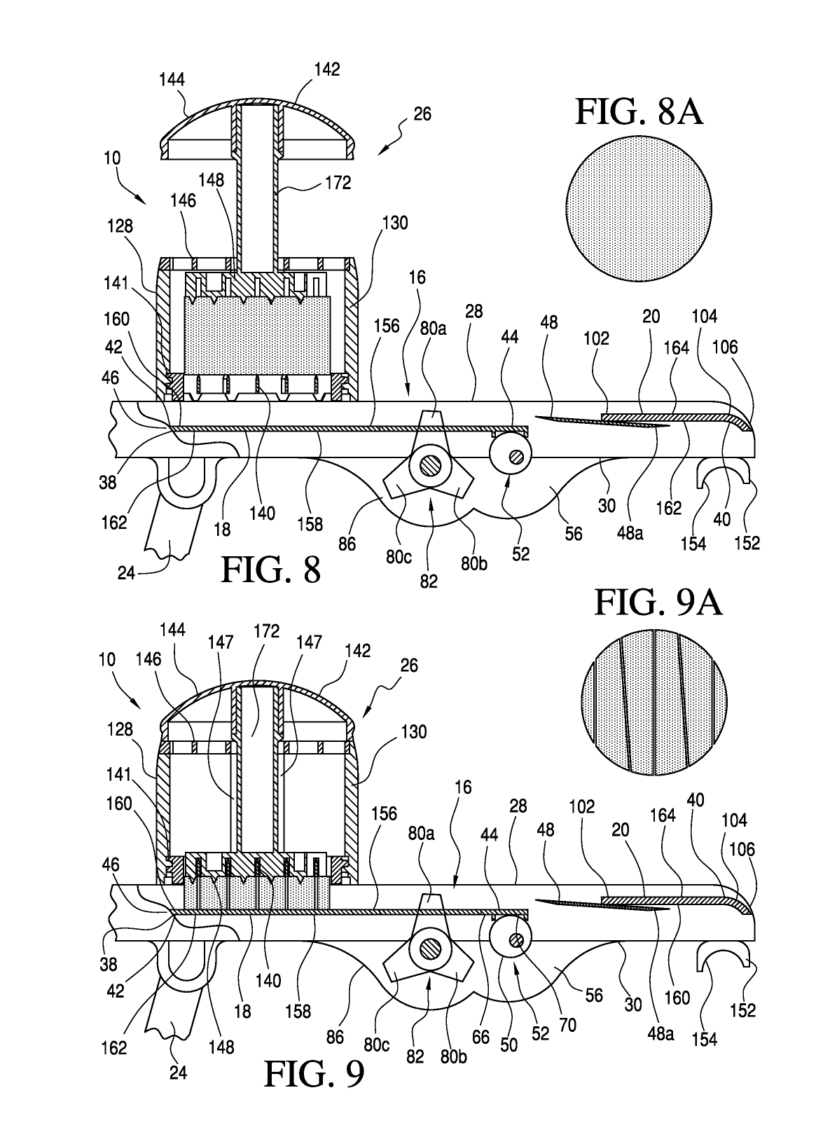

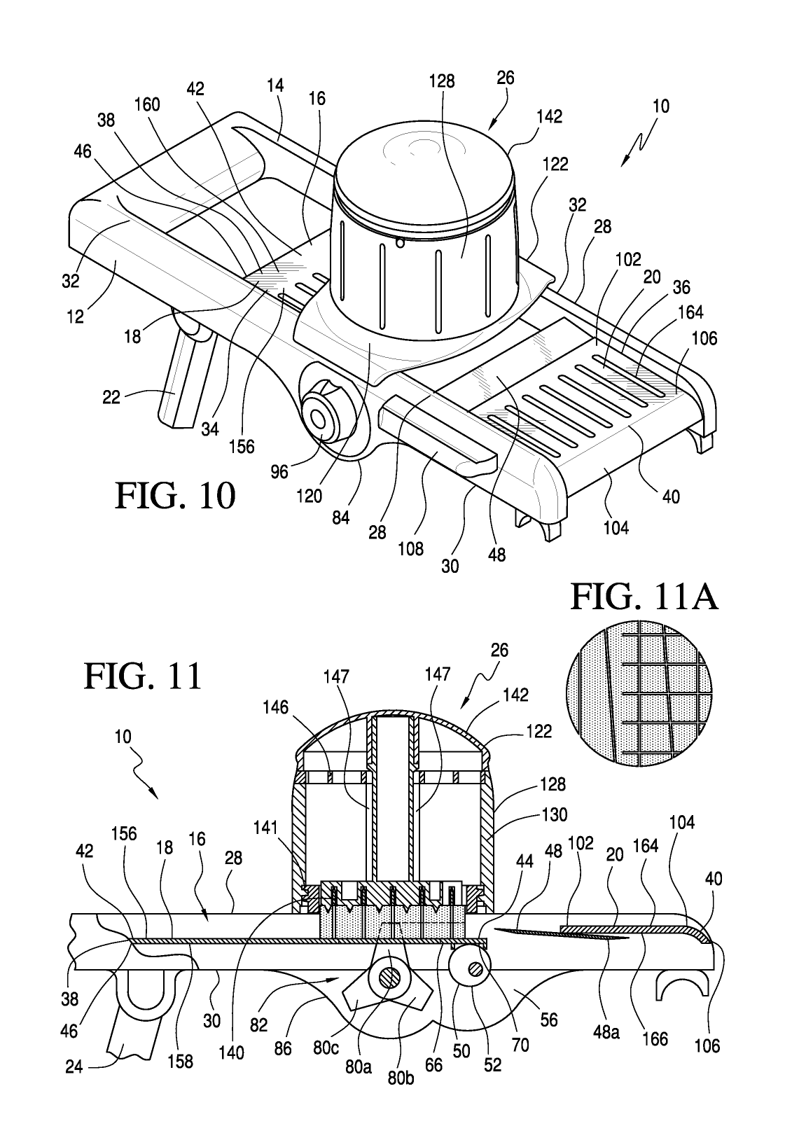

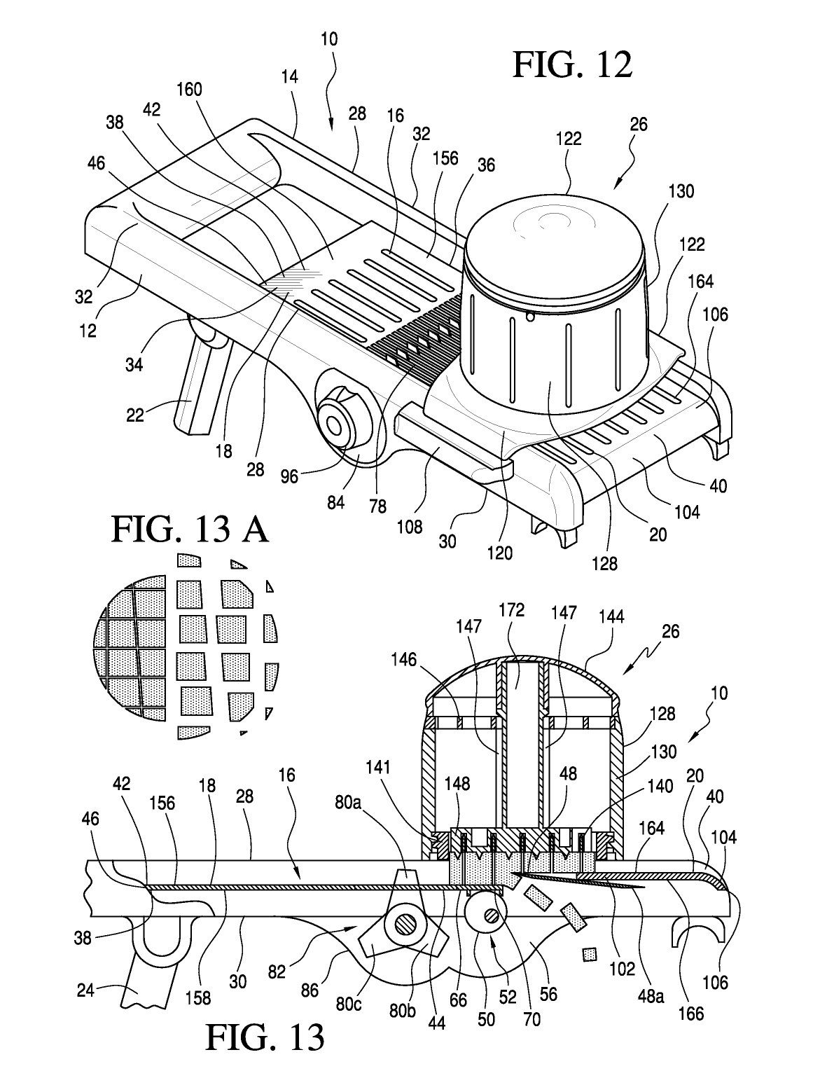

The slide 26 is then placed upon the first and second rails 12, 14 with the first end 120 of the slide 26 sitting upon the top end 28 of the first rail 12 and the second end 122 of the slide 26 sitting upon the top end 28 of the second rail 14 (see FIGS. 8 and 8A). Referring to FIGS. 9 and 9A, the pressure from the compression member 142 will cause the food product stored within the outer housing 130 to push downwardly such that the food product crosses the slide cutting blades 140 creating a cut in the food product as shown at Cut 1 of FIG. 9A. The food product is pushed downward until the exposed end hits the upper surface 156 of the food deck 16. The slide 26 is then moved from the distal end 46 of the food deck 16 toward the proximal end 106 of the food deck 16. As the food product is moved downwardly along the food deck 16, the elongated parallel cutting blades 80 will cut, or score, the food product in a parallel direction, that is, parallel to the direction in which the food product is being moved along the food deck 16 creating cuts as shown in FIG. 11A (see also FIGS. 10 and 11). With the food product now cut in first, x-direction and second, y-direction along planes perpendicular to the upper surface 156 of the food deck 16, the food product is drawn across the parallel cutting blade 48 and cut along a plane which is substantially parallel to the plane in which the upper surface 156 of the food deck 16 lies to create the cut as shown with reference to in FIG. 13A along the z-direction (see also FIGS. 12 and 13). As a result, the present mandolin 10 creates a 3-dimensional cut resulting in the dicing of the food product in a highly controlled and convenient manner.

The present mandolin may be manufactured from a variety of materials, for example, co-molded plastics. In addition, the present mandolin may be employed in cutting a wide variety of food products.

While the preferred embodiments have been shown and described, it will be understood that there is no intent to limit the invention by such disclosure, but rather, is intended to cover all modifications and alternate constructions falling within the spirit and scope of the invention.

1. A mandolin, comprising:
a food deck including an adjustable first food deck and a fixed second food deck;
a slide which selectively engages food products as they are moved along the food deck;
a parallel cutting blade positioned between the first food deck and the second food deck, wherein the parallel cutting blade cuts food product along a plane which is substantially parallel to a plane in which an upper surface of the second food deck lies;
a plurality of elongated perpendicular cutting blades mounted along the first food deck for engagement with food product prior to engagement of the food product with the parallel cutting blade, the elongated cutting blades being oriented to longitudinally extend along an axis substantially parallel to the longitudinal axis of the food deck and to cut the food product in a plane which is substantially perpendicular to the plane in which the upper surface of the first food deck lies and which extends substantially parallel to the longitudinal axis of the food deck;
the slide including a series of transverse slide cutting blades, the slide cutting blades being oriented to cut food products along a plane which is substantially perpendicular to the upper surface of the food deck when the slide is positioned for operation adjacent the food deck and perpendicular to the longitudinal axis of the food deck.

2. The mandolin according to claim 1, wherein the mandolin includes a first rail and a second rail supporting the food deck.

3. The mandolin according to claim 2, further including a first leg and a second leg respectively depending from the first rail and the second rail for supporting the food deck at a desired angular orientation.

4. The mandolin according to claim 1, wherein the food deck includes a first end and a second end, and the first food deck constitutes the first end of the food deck while the second food deck constitutes the second end of the food deck, such that a user may move food product between the first end and the second end of the food deck in a manner causing the slicing of the food product.

5. The mandolin according to claim 4, wherein the first food deck includes a first end and a second end, and the second end of the first food deck is adjustable relative to the parallel cutting blade and the second food deck.

6. The mandolin according to claim 5, further including a rotatable camming surface acting upon the second end of the first food deck in a manner allowing for raising and lowering of the second end of the first food deck.

7. The mandolin according to claim 2, wherein the second end of the first food deck includes a plurality of longitudinally extending slots oriented substantially parallel to the longitudinal axis of the food deck and a plurality of elongated perpendicular cutting blades mounted beneath the first food deck for selective extension through the longitudinally extending slots.

8. The mandolin according to claim 7, wherein elongated cutting blades are oriented to longitudinally extend along an axis substantially parallel to the longitudinal axis of the food deck and to cut the food product in a plane which is substantially perpendicular to the plane in which the upper surface of the first food deck lies and which extends substantially parallel to the longitudinal axis of the food deck 16.

9. The mandolin according to claim 7, wherein the elongated perpendicular cutting blades are aligned with the slots formed in the second end of the first food deck for movement between a first storage position where the elongated perpendicular cutting blades are stored beneath the first food deck and a second use position where the elongated perpendicular cutting blades extend through the slots formed in the second end of the first food deck,

10. The mandolin according to claim 9, wherein the elongated perpendicular cutting blades are supported by a blade support assembly rotationally supporting the elongated perpendicular cutting blades for movement between the storage position and the use position.

11. The mandolin according to claim 1, wherein the slide includes a food support capsule mounted between a first end and the second end of the slide, the capsule is shaped and dimensioned for receiving food product and supporting the food product along a position such that the food product may be brought into engagement with the elongated perpendicular cutting blades and the parallel blade.

12. The mandolin according to claim 11, wherein the capsule includes an outer housing that is substantially cylindrical in shape and includes a first open end and a second open end.

13. The mandolin according to claim 12, wherein transverse slide cutting blades are mounted within the outer housing at a position adjacent the second open end of the outer housing.

14. The mandolin according to claim 13, further including a compression member that holds the food product as it is positioned within the outer housing and forces the food from the first open end of the outer housing, toward the second open end of the outer housing and through the slide cutting blades at the first open end of the outer housing.

15. The mandolin according to claim 1, wherein the slide cutting blades are obliquely oriented.
